(19) United States
(12) Patent Application Publication
(10) Pub. No.: US 2022/0241724 A1
(43) Pub. Date: Aug. 4, 2022

(54) BIOLOGICAL DESULFURIZATION PROCESSING METHOD AND BIOLOGICAL DESULFURIZATION PROCESSING SYSTEM

(71) Applicant: INDUSTRIAL TECHNOLOGY RESEARCH INSTITUTE, Hsinchu (TW)

(72) Inventors: Jia-Jun TEE, Hsinchu City (TW); Laurensia IRMAYANI, Hsinchu City (TW); Wun-Jie HUANG, Taoyuan City (TW); Hsin-Ju HSIEH, Hsinchu City (TW); Shing-Der CHEN, Chiayi City (TW); Ren-Yang HORNG, Zhubei City (TW); Jer-Young CHEN, Hsinchu City (TW)

(73) Assignee: INDUSTRIAL TECHNOLOGY RESEARCH INSTITUTE, Hsinchu (TW)

(21) Appl. No.: 17/560,516

(22) Filed: Dec. 23, 2021

Related U.S. Application Data
(60) Provisional application No. 63/145,142, filed on Feb. 3, 2021.

(51) Int. Cl. B01D 53/85; B01D 53/52

(52) U.S. Cl. CPC B01D 53/85; B01D 53/52

(57) ABSTRACT

A biological desulfurization processing system is provided. The biological desulfurization processing system includes a desulfurization reaction tank and a culture tank of desulfurization bacteria. The culture tank of desulfurization bacteria is used for cultivating desulfurization bacteria and is connected to the desulfurization reaction tank. The desulfurization reaction tank includes a desulfurization reaction zone. The desulfurization reaction zone includes at least one desulfurization layer and at least one supporting layer, and the desulfurization layer and the supporting layer are stacked in a staggered manner. A biological desulfurization processing method is also provided.

### CROSS REFERENCE TO RELATED APPLICATIONS

This application claims the benefit of U.S. Provisional Application No. U.S. 63/145,142, filed Feb. 3, 2021, the entirety of which is incorporated by reference herein.

### TECHNICAL FIELD

The technical field of the present disclosure is related to a biological desulfurization processing system and a biological desulfurization processing method.

### BACKGROUND

The components of biogas generally include methane gas, carbon dioxide gas, and hydrogen sulfide gas (usually at a concentration between 200 ppmv and 8000 ppmv). Since biogas is a greenhouse gas, it can be used for heating and power generation. However, the hydrogen sulfide in the biogas will produce odors, cause environmental pollution, and may corrode power-generation equipment. Therefore, reducing the content of hydrogen sulfide in the biogas is an important issue.

Currently, the desulfurization methods that are commonly used are mainly divided into chemical desulfurization methods and biological desulfurization methods. Chemical desulfurization methods mostly use the adsorption desulfurization technique (for example, activated carbon and iron oxide, etc.) and the absorption desulfurization technique (for example, a water scrubbing technique and an alkaline water scrubbing technique, etc.). However, chemical desulfurization methods have problems such as high power consumption and the need to regularly replace the adsorbent materials, and it is necessary to consider the processing of the replaced adsorbent materials. Biological desulfurization methods use microorganisms to carry out the oxidation reaction of hydrogen sulfide, and do not produce secondary pollutants. They can also recover elemental sulfur or process sulfate wastewater, which are environmentally friendly, but the initial installation cost of biological desulfurization equipment is relatively high.

In view of the foregoing, although the existing desulfurization techniques can substantially satisfy their original intended use, they have not yet met the requirements in all aspects. The development of a desulfurization system with high efficiency, high stability and low cost is still a topic of concern in related fields.

### SUMMARY

In accordance with an embodiment of the present disclosure, a biological desulfurization processing method is provided. The method includes providing a biological desulfurization processing system. The biological desulfurization processing system includes a desulfurization reaction tank and a culture tank of desulfurization bacteria. The desulfurization reaction tank is used for receiving a gas containing hydrogen sulfide. The culture tank of desulfurization bacteria is used for cultivating desulfurization bacteria and is connected to the desulfurization reaction tank. The desulfurization reaction tank includes a desulfurization reaction zone, and the desulfurization reaction zone includes at least one desulfurization layer and at least one supporting layer. The desulfurization layer and the supporting layer are stacked in a staggered manner. The biological desulfurization processing method further includes loading a gas containing hydrogen sulfide into the biological desulfurization processing system, allowing the gas containing hydrogen sulfide to pass through the desulfurization reaction zone for a desulfurization reaction to remove hydrogen sulfide; and discharging the gas that has been desulfurized from the desulfurization reaction tank.

In accordance with another embodiment of the present disclosure, a biological desulfurization processing system is provided. The biological desulfurization processing system includes a desulfurization reaction tank and a culture tank of desulfurization bacteria. The culture tank of desulfurization bacteria is used for cultivating desulfurization bacteria and is connected to the desulfurization reaction tank. The desulfurization reaction tank includes a desulfurization reaction zone. The desulfurization reaction zone includes at least one desulfurization layer and at least one supporting layer, and the desulfurization layer and the supporting layer are stacked in a staggered manner.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1 is a schematic diagram of a biological desulfurization processing system in accordance with an embodiment of the present disclosure;

FIG. 2 is the desulfurization capacity test results obtained by using a biological desulfurization processing system according to an embodiment of the present disclosure, which shows the relationship between the loading rate of hydrogen sulfide and the elimination capacity/removal efficiency.

### DETAILED DESCRIPTION

The biological desulfurization processing system and the biological desulfurization processing method of the present disclosure are described in detail in the following description. It should be understood that in the following detailed description, for purposes of explanation, numerous specific details and embodiments are set forth in order to provide a thorough understanding of the present disclosure. The elements and configurations described in the following detailed description are set forth in order to clearly describe the present disclosure. These embodiments are used merely for the purpose of illustration, and the present disclosure is not limited thereto. In addition, different embodiments may use like and/or corresponding numerals to denote like and/or corresponding elements in order to clearly describe the present disclosure. However, the use of like and/or corresponding numerals of different embodiments does not suggest any correlation between different embodiments.

The present disclosure can be understood by referring to the following detailed description in connection with the accompanying drawings. It should be understood that the drawings of the present disclosure may be not drawn to scale. In fact, the size of the elements may be arbitrarily enlarged or reduced to clearly show the features of the present disclosure.

In addition, in the embodiments, relative expressions may be used. For example, “lower”, “bottom”, “higher” or “top” are used to describe the position of one element relative to another. It should be appreciated that if a device is flipped upside down, an element that is “lower” will become an element that is “higher”.

Furthermore, it should be understood that, although the terms “first”, “second”, “third” etc. may be used herein to describe various elements, layers, regions, or portions, these elements, layers, regions, or portions should not be limited by these terms. These terms are only used to distinguish one element, layer, region, or portion from another element, layer, region, or portion. Thus, a first element, layer, region, or portion discussed below could be termed a second element, layer, region, or portion without departing from the teachings of the present disclosure.

Moreover, in accordance with the embodiments of the present disclosure, regarding the terms such as “connected”, “interconnected”, etc. referring to bonding and connection, unless specifically defined, these terms mean that two structures are in direct contact, or two structures are not in direct contact and other structures are provided to be disposed between the two structures.

In the context, the terms “about” and “substantially” typically mean +/−10% of the stated value, or typically +/−5% of the stated value, or typically +/−3% of the stated value, or typically +/−2% of the stated value, or typically +/−1% of the stated value or typically +/−0.5% of the stated value. The stated value of the present disclosure is an approximate value. When there is no specific description, the stated value includes the meaning of “about” or “substantially”. In addition, the term “in a range from the first value to the second value” or “between the first value and the second value” means that the range includes the first value, the second value, and other values in between.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

The embodiments of the present disclosure provide a biological desulfurization processing system, including a desulfurization reaction tank and a culture tank of desulfurization bacteria. The desulfurization reaction tank includes desulfurization layer(s) and supporting layer(s) stacked in a staggered manner, which can effectively increase the time that the gas to be processed stays in the desulfurization reaction tank to contact the desulfurization bacteria, thereby improving the desulfurization efficiency. Furthermore, the desulfurization layer and supporting layer with specific physical properties can further improve the filling capacity of the desulfurization reaction tank and increase the load capacity of hydrogen sulfide, thereby reducing the initial setup cost of the processing system.

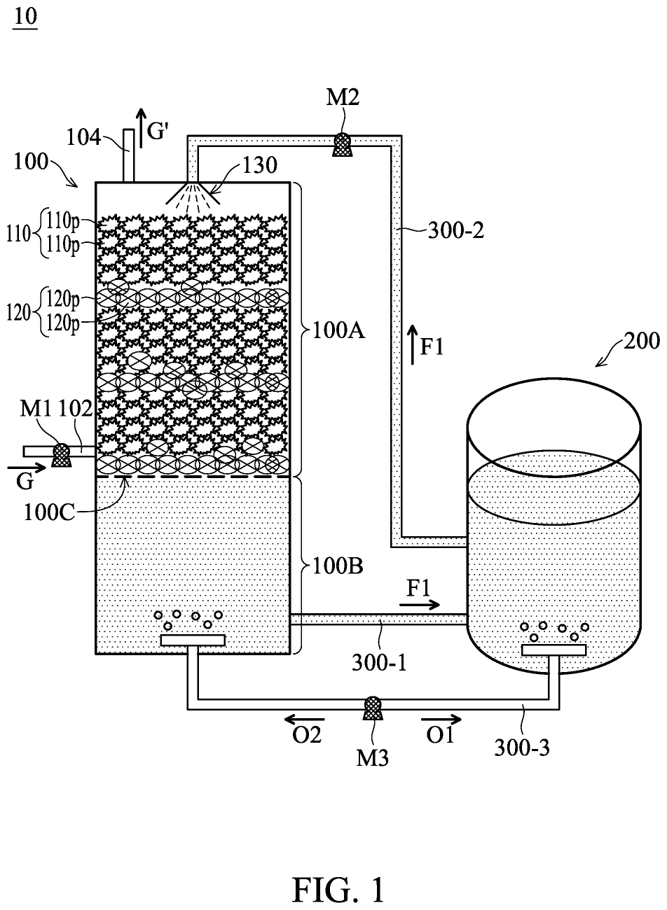

FIG. 1 is a schematic diagram of a biological desulfurization processing system 10 in accordance with an embodiment of the present disclosure. It should be understood that, for clear description, some elements of the biological desulfurization processing system 10 are omitted in the figure, and only some elements are schematically shown. In accordance with some embodiments, additional features can be added to the biological desulfurization processing system 10 described below.

Referring to FIG. 1, the biological desulfurization processing system 10 includes a desulfurization reaction tank 100 and a culture tank of desulfurization bacteria 200, and the culture tank of desulfurization bacteria 200 is connected to the desulfurization reaction tank 100. Specifically, in an embodiment, the culture tank of desulfurization bacteria 200 is connected to the top of the desulfurization reaction tank 100 through a connection part 300-2, and the desulfurization reaction tank 100 and the culture tank of desulfurization bacteria 200 are connected in series. The desulfurization reaction tank 100 is used for receiving a gas containing hydrogen sulfide and performing a desulfurization reaction on the gas containing hydrogen sulfide therein. The culture tank of desulfurization bacteria 200 is used for cultivating desulfurization bacteria. Furthermore, the desulfurization bacteria cultured in the culture tank of desulfurization bacteria 200 can be transported to the desulfurization reaction tank 100, and the desulfurization bacteria can react with the gas containing hydrogen sulfide to remove the hydrogen sulfide in the gas.

In another embodiment, the biological desulfurization processing system 10 may include a plurality of desulfurization reaction tanks 100 and a plurality of culture tanks of desulfurization bacteria 200 to process a greater amount of gas. The plurality of desulfurization reaction tanks 100 and the plurality of culture tanks of desulfurization bacteria 200 can be connected in the aforementioned manner. For example, in some embodiments, the biological desulfurization processing system 10 may include two to five desulfurization reaction tanks 100 and two to five culture tanks of desulfurization bacteria 200.

In some embodiments, the desulfurization reaction tank 100 includes a desulfurization reaction zone 100A and a temporary storage zone 100B. The temporary storage zone 100B is located below the desulfurization reaction zone 100A and connected with the desulfurization reaction zone 100A. In a particular embodiment, a separator 100C is disposed between the desulfurization reaction zone 100A and the temporary storage zone 100B. The separator 100C divides the desulfurization reaction tank 100 into the desulfurization reaction zone 100A and the temporary storage zone 100B. The separator 100C may have a plurality of holes allow fluid to circulate between the desulfurization reaction zone 100A and the temporary storage zone 100B.

In an embodiment, the height of the desulfurization reaction zone 100A is in range from 2 meters (m) to 4 meters. In an embodiment, the height of the temporary storage zone 100B is in a range from 1 meter to 2 meters.

In an embodiment, the tank body material of the desulfurization reaction tank 100 and the culture tank of desulfurization bacteria 200 may include, for example, polypropylene, polyethylene, or other suitable corrosion-resistant materials.

In addition, the desulfurization reaction zone 100A includes at least one desulfurization layer 110 and at least one supporting layer 120, and the desulfurization layer 110 and the supporting layer 120 are stacked in a staggered manner. Specifically, in a particular embodiment, the supporting layer 120 is first disposed on the separator 100C, then the desulfurization layer 110 is disposed on the supporting layer 120, and they are sequentially stacked in this order (e.g., the desulfurization layer 110, the supporting layer 120, the desulfurization layer 110, and the supporting layer 120 . . . are sequentially arranged from bottom to top), but the present disclosure is not limited thereto. Alternatively, in some other embodiments, the desulfurization layer 110 is first disposed on the separator 100C, and then the supporting layer 120 is disposed on the desulfurization layer 110, and they are sequentially stacked in this order (e.g., the supporting layer 120, the desulfurization layer 110, the supporting layer 120, and the desulfurization layer 110 . . . are sequentially arranged from bottom to top).

In some embodiments, the desulfurization layer 110 each includes a plurality of porous bio-carriers 110p, the supporting layer 120 each includes a plurality of supporting elements 120p, and the porous bio-carriers 110p are greater in number than the supporting elements 120p. The porous bio-carrier 110p can provide an environment for the attachment and growth of desulfurization bacteria. The supporting element 120p can provide physical support to prevent the porous bio-carriers 110p disposed above it from being over-compressed to cause airtightness and affecting system operation. It should be understood that since the desulfurization layer 110 and the supporting layer 120 respectively include a plurality of porous bio-carriers 110p and a plurality of supporting elements 120p, in some cases, for example, at the interface between the desulfurization layer 110 and the supporting layer 120, some of the porous bio-carriers 110p may be mixed with the supporting elements 120p.

In an embodiment, one desulfurization layer 110 and one supporting layer 120 constitute a set of desulfurization unit, and the biological desulfurization processing system 10 may include 2 to 10 sets, or 2 to 8 sets of desulfurization units, for example, 3 sets, 4 sets, 5 sets, 6 sets, or 7 sets, but it is not limited thereto. In various embodiments, the number of desulfurization units can also be adjusted according to the actual situation in which the biological desulfurization processing system 10 is applied. In some embodiments, the ratio of the height of one desulfurization unit to the height of the desulfurization reaction zone 100A is between 1:1.5 and 1:6.5, or is between 1:2.5 and 1:5.5, for example, 1:3.5 or 1:4.5, but it is not limited thereto.

In some embodiments, the ratio of the total volume of the plurality of desulfurization layers 110 to the total volume of the plurality of supporting layers 120 (can also be regarded as the ratio of the total volume of the porous bio-carriers 110p to the total volume of the supporting element 120p) is between 2:1 and 5:1, for example, 3:1 or 4:1. In addition, in some embodiments, in a desulfurization unit, the ratio of the volume of the desulfurization layer 110 to the volume of the supporting layer 120 is also between 2:1 and 5:1, for example, 3:1 or 4:1.

It should be noted that if the volume ratio of the desulfurization layers 110 to the supporting layers 120 is too small (for example, less than 2:1), the desulfurization efficiency of the biological desulfurization processing system 10 may be decreased due to the insufficient amount of porous bio-carriers 110p. On the other hand, if the volume ratio of the desulfurization layers 110 to the supporting layers 120 is too large (for example, greater than 5:1), the supporting layer 120 may not be able to provide sufficient physical support so that the porous bio-carriers 110p are excessively compressed and cause airtightness.

In an embodiment, the compressibility of the porous bio-carrier 110p is greater than the compressibility of the supporting element 120p. In some embodiments, the hardness of the porous bio-carrier 110p is less than the hardness of the supporting element 120p. In some embodiments, the pore size of the porous bio-carrier 110p is in a range from 200 micrometers (μm) to 2000 μm, or in a range from 1500 μm to 2000 μm. In some embodiments, the porosity of the porous bio-carrier 110p is less than the porosity of the supporting element 120p. Specifically, the porosity of the porous bio-carrier 110p may be greater than 80%, for example, in a range from 80% to 85%, and the porosity of the supporting element 120p may be greater than 90%, for example, in a range from 90% to 95%. In a particular embodiment, the supporting element 120p may be a hollow shell, and a part of the porous bio-carriers 110p may be disposed in the supporting element 120p.

In addition, in another embodiment, the specific surface area of the porous bio-carrier 110p is greater than the specific surface area of the supporting element 120p. Specifically, in some embodiments, the specific surface area of the porous bio-carrier 110p is in a range from 800 m²/m³ to 8000 m²/m³, or in a range from 800 m²/m³ to 4000 m²/m³, and the specific surface area of the supporting element 120p is in a range from 150 m²/m³ to 500 m²/m³.

Furthermore, as described above, the desulfurization reaction tank 100 includes the separator 100C, and the separator 100C has a plurality of holes. In some embodiments, both the porous bio-carrier 110p and the supporting element 120p have the size (e.g., diameter) larger than the size (e.g., diameter) of the hole of the separator 100C. In this way, the porous bio-carrier 110p or the supporting element 120p can be prevented from blocking the holes and disturbing the fluid circulation between the desulfurization reaction zone 100A and the temporary storage zone 100B.

In some embodiments, the material of the porous bio-carrier 110p may include, but is not limited to, polyurethane (PU), porous foam, polyvinyl alcohol (PVA), polyethylene (PE), or a combination thereof In some embodiments, the material of the supporting element 120p may include, but is not limited to, polyurethane (PU), polyethylene (PE), polypropylene (PP), polyvinyl chloride (PVC), poly(methyl methacrylate) (PMMA), Teflon, polyvinylidene chloride (PVDF), ceramic, carbon steel, or a combination thereof.

It should be noted that the aforementioned porous bio-carrier 110p with high specific surface area, high porosity and high permeability can provide desulfurization bacteria (for example, autotroph aerobic desulfurization bacteria) with a good environment for attachment and growth, thereby the removal processing of high concentration of hydrogen sulfide can be carried out. In detail, the porous bio-carrier 110p can effectively intercept hydrogen sulfide gas, increase the gas residence time, and avoid short circuits in air flow. Meanwhile, it can also increase the contact area and contact time between hydrogen sulfide gas and the circulating fluid, and increase the reaction time of the desulfurization.

Furthermore, since the supporting layer 120 consists of a plurality of supporting elements 120p instead of being a supporting layer with a plate structure, it can overcome the following problems that easily occur when the plate-structure supporting layer is used. For example, the number and density of circulation holes are limited by the area of the plate structure; if the porous bio-carriers are used for a long time, the porous bio-carriers will be excessively compressed and blocked in the circulation holes due to the attachment of elemental sulfur or microorganisms, which will affect the operation of the system. Moreover, when the backwash operation is performed, the desulfurization layers and the supporting layers are not easy to be disturbed and cannot effectively achieve the effect of backwashing.

In addition, by using the aforementioned combination of the porous bio-carriers 110p and the supporting elements 120p with specific physical properties and the specific arrangement of the desulfurization layer 110 and the supporting layer 120, the filling capacity of the porous bio-carriers 110p and the supporting elements 120p in the desulfurization reaction zone 100A (that is, the filling capacity of carriers) can be effectively improved. In addition, the load of hydrogen sulfide that the biological desulfurization processing system 10 can bear may be improved. Specifically, in some embodiments, the filling capacity (filling rate) of the porous bio-carriers 110p and the supporting elements 120p in the desulfurization reaction zone 100A is in a range from 80% to 95%, or in a range from 90% to 95%. In some embodiments, the volumetric loading rate of hydrogen sulfide of the biological desulfurization processing system 10 is in a range from 30 gH₂S/m³hr to 250 gH₂S/m³hr, or in a range from 30 gH₂S/m³hr to 210 gH₂S/m³hr, or in a range from 30 gH₂S/m³hr to 160 gH₂S/m³hr.

In addition, by using the aforementioned combination of the porous bio-carriers 110p and the supporting elements 120p with specific physical properties and the specific arrangement of the desulfurization layer 110 and the supporting layer 120, the biological desulfurization processing system 10 is able to operate at a high trickling flow rate, and can stably provide a large amount of dissolved oxygen for desulfurization bacteria. Specifically, in some embodiments, the trickling flow rate of the circulating fluid in the biological desulfurization processing system 10 is in a range from 20 meters per hour (m/hr) to 50 m/hr, for example, 30 m/hr or 40 m/hr. It should be noted that if the trickling flow rate of the circulating fluid is too low (for example, less than 20 m/hr), it will affect the transportation efficiency of oxygen and the dissolution rate of hydrogen sulfide, resulting in poor desulfurization performance. The operation mode of the biological desulfurization processing system 10 will be described in detail later.

It is worth noting that in the biological trickling filter bed technology, the carrier filling capacity and the trickling flow rate are two important system parameters. Specifically, the high filling capacity means that each unit volume of the desulfurization reaction tank can withstand more hydrogen sulfide. Therefore, under the same hydrogen sulfide processing load, the biological desulfurization processing system can maintain a high efficiency of hydrogen sulfide removal with a relatively small tank volume. Accordingly, the initial setup cost of the processing system can be reduced.

Referring to FIG. 1, in some embodiments, a sprinkler 130 is disposed at the top of the desulfurization reaction tank 100. The sprinkler 130 can control the flow rate of the fluid entering the desulfurization reaction tank 100, and can atomize the fluid and reduce the size of the fluid droplets, thereby increasing the contact surface area between the fluid and the gas. In addition, in some embodiments, the desulfurization reaction tank 100 further includes a gas inlet 102 and a gas outlet 104. The gas inlet 102 is disposed on the side surface of the desulfurization reaction tank 100 and corresponds to the desulfurization reaction zone 100A, and the gas outlet 104 is disposed at the top of the desulfurization reaction tank 100. Specifically, in some embodiments, a gas containing hydrogen sulfide G enters the desulfurization reaction zone 100A of the desulfurization reaction tank 100 from the gas inlet 102. After the desulfurization reaction proceeds, the gas that has been desulfurized G′ is discharged from the desulfurization reaction tank 100 from the gas outlet 104. In addition, in some embodiments, an intake motor M1 is disposed at the gas inlet 102, and the intake motor M1 can introduce the gas containing hydrogen sulfide into the desulfurization reaction tank 100, and control the intake flow rate and the like.

In some embodiments, the temporary storage zone 100B is connected to the culture tank of desulfurization bacteria 200 through a connection part 300-1. Specifically, the connection part 300-1 may be disposed between the side surface of the desulfurization reaction tank 100 corresponding to the temporary storage zone 100B and the side surface of the culture tank of desulfurization bacteria 200. In addition, in some embodiments, the culture tank of desulfurization bacteria 200 is connected to the top of the desulfurization reaction tank 100 through the connection part 300-2. Specifically, the connection part 300-2 may be disposed between the top surface of the desulfurization reaction tank 100 corresponding to the desulfurization reaction zone 100A and the side surface of the culture tank of desulfurization bacteria 200. In some embodiments, the connection part 300-2 is connected to a circulating motor M2, the circulating motor M2 is disposed at the connection part 300-2, and the circulating motor M2 can provide power to make the fluid circulate between the culture tank of desulfurization bacteria 200 and the desulfurization reaction tank 100. For example, the fluid and the desulfurization bacteria in the culture tank of desulfurization bacteria 200 are transported to the desulfurization reaction tank 100, and the fluid in the temporary storage zone 100B of the desulfurization reaction tank 100 is transported back to the culture tank of desulfurization bacteria 200.

In some embodiments, the connection part 300-1 and the connection part 300-2 includes pipes. The material of the pipe may include metal, non-metal, or a combination thereof. For example, the aforementioned metal may include, but is not limited to, stainless steel, copper, aluminum, or a combination thereof. The aforementioned non-metal may include, but is not limited to, silicone, Teflon, rubber or plastics (for example, polyurethane (PU), polypropylene (PP), polyvinyl fluoride (PVC), polyethylene (PE), polymethyl methacrylate (PMMA)), or a combination thereof.

In addition, as shown in FIG. 1, in some embodiments, the biological desulfurization processing system 10 further includes an aeration device M3. The aeration device M3 is connected to the bottom of the desulfurization reaction tank 100 and the bottom of the culture tank of desulfurization bacteria 200 through a connection part 300-3. In some embodiments, the aeration device M3 is connected to the desulfurization reaction tank 100 and the culture tank of desulfurization bacteria 200 through different connection parts 300-3, and can separately aerate the desulfurization reaction tank 100 and the culture tank of desulfurization bacteria 200 according to different needs (for example, desulfurization mode or cleaning mode etc.).

Specifically, the culture tank of desulfurization bacteria 200 can provide sufficient oxygen for use of the desulfurization bacteria by using aeration method, and convert reduced hydrogen sulfide into oxidized sulfate, thereby achieving the goal of high efficiency desulfurization. In addition, it should be noted that since the culture tank of desulfurization bacteria 200 adopts an external aeration method to proliferate a large number of desulfurization bacteria, it can prevent the air from being mixed with the gas containing hydrogen sulfide G and affecting its composition. Furthermore, the desulfurization reaction tank 100 can be backwashed by using the aeration device M3 to wash away elemental sulfur and aging desulfurization bacteria accumulated in the desulfurization reaction zone 100A.

In some embodiments, the culture tank of desulfurization bacteria 200 may be further configured with controllers (not illustrated) of pH, redox potential, dissolved oxygen, and conductivity. The controllers of pH, redox potential, dissolved oxygen, and conductivity can be used to monitor the pH, oxidation-reduction potential, dissolved oxygen, conductivity and other water quality parameters of the substances in the culture tank of desulfurization bacteria 200. The timing of changing the system water or adding nutrient substrates can be determined according to the changes in the values of water quality parameters such as pH, oxidation-reduction potential, dissolved oxygen, and conductivity.

In addition, a biological desulfurization processing method is also provided in the present disclosure. The method includes using the aforementioned biological desulfurization processing system 10 for desulfurization of gas. The operation mode of the biological desulfurization processing system 10 will be used to illustrate the biological desulfurization processing method. It should be understood that, in according with some embodiments, additional steps may be added before, during, and/or after the biological desulfurization processing method described below, or some steps may be substituted or omitted.

As shown in FIG. 1, the gas containing hydrogen sulfide G is loaded into the biological desulfurization processing system 10, and the gas containing hydrogen sulfide G is passed through the desulfurization reaction zone 100A for desulfurization reaction to remove the hydrogen sulfide. In detail, the gas containing hydrogen sulfide G can enter the desulfurization reaction zone 100A of the desulfurization reaction tank 100 through the gas inlet 102 by turning on the intake motor M1. In some embodiments, the gas containing hydrogen sulfide G may include biogas, but it is not limited thereto. In some embodiments, the inlet flow rate of the gas containing hydrogen sulfide G may be in range from 0.01 m³/min to 10 m³/min, or in range from 1 m³/min to 8 m³/min.

After the gas containing hydrogen sulfide G enters the desulfurization reaction tank 100, it moves upward from the bottom of the desulfurization reaction zone 100A, and reacts with the desulfurization bacteria attached on the desulfurization layer 110 and the supporting layer 120 to oxidize the reduced sulfide ions (S²⁻) of the hydrogen sulfide to elemental sulfurs (S⁰) and sulfate ions (SO₄²⁻). The gas containing hydrogen sulfide G thereby undergoes the desulfurization reaction. After the gas containing hydrogen sulfide G undergoes the desulfurization reaction, the gas that has been desulfurized G′ is discharged from the desulfurization reaction tank 100 through the gas outlet 104.

In some embodiments, the desulfurization bacteria may be autotroph desulfurization bacteria, including Acidithiobacillus spp., Mycobacterium spp., Thiomonas spp. or other suitable desulfurization bacteria. Specifically, in the desulfurization reaction tank 100, the gas containing hydrogen sulfide G reacts with oxygen in the circulating fluid (Equation 1), and undergoes an oxidation-reduction reaction with desulfurization bacteria in an aerobic environment (Equation 2 and Equation 3). The chemical reaction equations are as follows:

$$\begin{matrix}{H}_{2} S + 0.5 {O}_{2} \to {S}^{0} + 2 {H}_{2} O ( - 20 \; 9 kJ / reaction ; {O}_{2} / {H}_{2} S = 0.5 ) & [ Equation 1 ] \\ {S}^{0} + 1.5 {O}_{2} + {H}_{2} O \to {SO}_{4}^{2 -} + 2 {H}^{+} ( - 587 kJ / reaction ; {O}_{2} / {H}_{2} S = 1.5 & [ Equation 2 ] \\ {H}_{2} S + 2 {O}_{2} \to {SO}_{4}^{2 -} + 2 {H}^{+} ( - 7 \; 98 kJ / reaction ; {O}_{2} / {H}_{2} S = 2.0 ) & [ Equation 3 ]\end{matrix}$$

According to an embodiment of the present disclosure, the biological desulfurization processing system 10 can be operated with a high trickling flow rate, and can stably provide a large amount of dissolved oxygen for the use of desulfurization bacteria. As shown above, in the case of sufficient oxygen (for example, the ratio of oxygen to hydrogen sulfide is greater than 1.5), the generation of elemental sulfur can be avoided (Equation 1), so that the final reaction product of the gas containing hydrogen sulfide G in the desulfurization reaction tank 100 is sulfate (as shown in Equation 2 and Equation 3). Moreover, under the operation of high trickling flow rate, the dissolved amount of carbon dioxide (which can be used as a carbon source for autotroph microorganisms) and hydrogen sulfide (target reactant) in the biogas are relatively increased, so the processing system can provide the autotroph desulfurization bacteria with a more favorable environment for reaction.

The biological desulfurization processing system 10 provided in the embodiments of the present disclosure may adopt a desulfurization mode and a cleaning mode. The desulfurization mode is described first. During the desulfurization mode, the fluid in the desulfurization reaction tank 100 and the culture tank of desulfurization bacteria 200 are circulated. Referring to FIG. 1, the desulfurization bacteria in the culture tank of desulfurization bacteria 200 is transported to the desulfurization reaction tank 100 by a circulating fluid F1 (the arrow in the figure can be interpreted as the flow direction of the fluid), and attached to the desulfurization layer 110 of the desulfurization reaction zone 100A. The desulfurization bacteria in the desulfurization reaction zone 100A will desulfurize the gas containing hydrogen sulfide G. The detailed reaction steps of the desulfurization bacteria and hydrogen sulfide are as described above, and thus will not be repeated herein.

As described above, the culture tank of desulfurization bacteria 200 can be connected to the desulfurization reaction tank 100 through the connection part 300-2. In some embodiments, the culture tank of desulfurization bacteria 200 may include desulfurization bacteria, water, sulfate ions, nutrient substrates, or other suitable components therein, and the circulating fluid F1 has the same composition. As mentioned above, the desulfurization bacteria cultured in the culture tank of desulfurization bacteria 200 may be autotroph desulfurization bacteria, including Acidithiobacillus spp., Mycobacterium spp., Thiomonas spp. or other suitable desulfurization bacteria. In some embodiments, the strains cultured in the culture tank of desulfurization bacteria 200 may include 40-50% Acidithiobacillus spp., 10-20% Mycobacterium spp., and 5-15% Thiomonas spp., but they are not limited thereto. In addition, in some embodiments, the culture tank of desulfurization bacteria 200 may further include other strains that are beneficial to the growth of microorganisms.

Next, the circulating fluid F1 flows from the desulfurization reaction zone 100A to the temporary storage zone 100B, and part of the products of the desulfurization reaction are also transported to the temporary storage zone 100B. For example, the sulfate ions generated after the desulfurization reaction are transported to the temporary storage zone 100B. Furthermore, as shown in FIG. 1, the temporary storage zone 100B is connected to the culture tank of desulfurization bacteria 200 through the connection part 300-1, so the circulating fluid F1 can be circulated to the culture tank of desulfurization bacteria 200 to provide nutrients for the desulphurization bacteria. Specifically, part of the elements or ions present in the circulating fluid F1 can be used as nutrient sources for desulfurization bacteria. It should be noted that the desulfurization reaction zone 100A adopts a reverse flow mode, that is, the traveling direction of the circulating fluid F1 is opposite to the traveling direction of the gas containing hydrogen sulfide G.

In addition, in the desulfurization mode of the biological desulfurization processing system 10, the aeration device M3 performs an operation O1 to transport air to the culture tank of desulfurization bacteria 200 (the arrow in the figure can be interpreted as the flow direction of the gas) to provide oxygen for desulfurization bacteria. In detail, the aeration device M3 can bring air into the culture tank of desulfurization bacteria 200 through the connection part 300-3 to increase the oxygen content of the fluid in the culture tank of desulfurization bacteria 200. In addition, since the culture tank of desulfurization bacteria 200 adopts an external aeration method to proliferate a large number of desulfurization bacteria, it is possible to prevent the air from being mixed with the gas containing hydrogen sulfide G and affecting its composition.

On the other hand, when the biological desulfurization processing system 10 is in the cleaning mode, the fluid circulation between the desulfurization reaction tank 100 and the culture tank of desulfurization bacteria 200 will be suspended first. In the cleaning mode, the aeration device M3 performs an operation O2 to transport air to the desulfurization reaction tank 100 (the arrow in the figure can be interpreted as the flow direction of the gas) to wash the desulfurization layer 110 and the supporting layer 120. In detail, the aeration device M3 can bring air into the temporary storage zone 100B and the desulfurization reaction zone 100A of the desulfurization reaction tank 100 through the connection part 300-3. In particular, due to the compressibility of the porous bio-carriers 110p combined with the backwashing operation, the elemental sulfur solids attached to the surface of the porous bio-carriers 110p can be effectively removed, and the aging desulfurization bacteria can be replaced. Therefore, the occupied reaction sites of the porous bio-carriers 110p can be released, and high desulfurization efficiency can be maintained. Moreover, the problems of short circuits in air flow caused by long-term operation can be avoided.

A detailed description is given in the following particular examples and comparative examples in order to provide a thorough understanding of the above and other objects, features and advantages of the present disclosure. However, the scope of the present disclosure is not intended to be limited to the particular examples.

### EXAMPLE 1

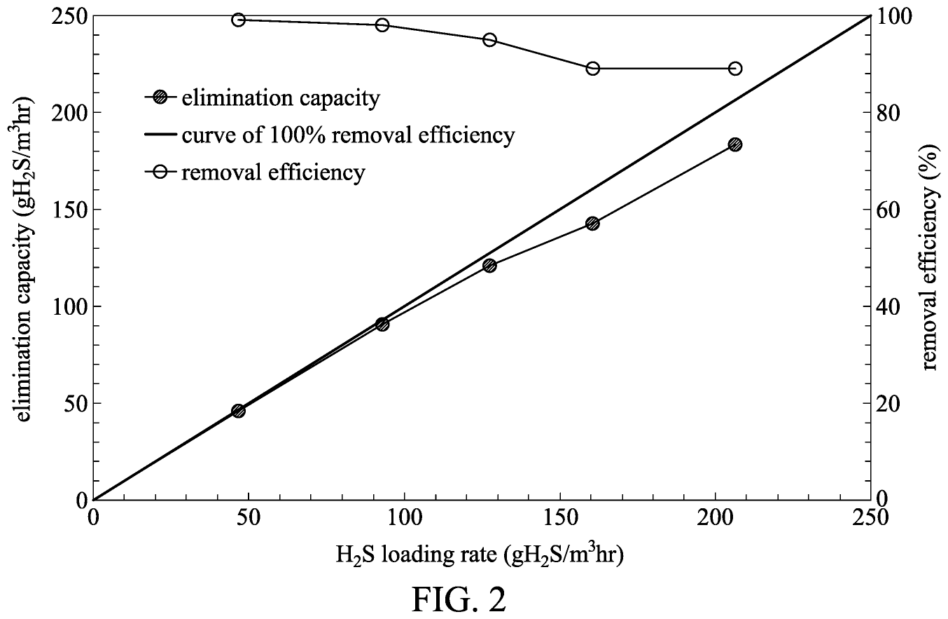

The aforementioned biological desulfurization processing system 10 was used to evaluate the desulfurization capability, the detailed steps are described as follows. First, the intake concentration of biogas was measured, and the quality of intake biogas was controlled (the concentration of methane is greater than 55%, and the concentration of carbon dioxide is less than 25%). Next, the intake motor was turned on (0.05 m³/min to 0.25 m³/min). After the intake motor was turned on, the circulating motor was turned on (9 m3/hr). After the biological desulfurization processing system 10 was processed (in desulfurization mode) for 1 hour, the gas concentration of the biogas was measured, the result was recorded, and the desulfurization efficiency was calculated (removal efficiency of hydrogen sulfide). Under five different conditions of loading rates of hydrogen sulfide, the desulfurization capacity test was carried out. Specifically, the desulfurization capacity test was carried out with a ton-level biological desulfurization processing system. Under five different loading rates of hydrogen sulfide (46, 93, 127, 160, 206 gH₂S/m³hr), the elimination capacity and removal efficiency of hydrogen sulfide were evaluated. The content and results of the experiments are shown in Table 1 and FIG. 2. Furthermore, the calculation of loading rate of hydrogen sulfide, elimination capacity and removal efficiency of hydrogen sulfide are as follows:

Hydrogen sulfide loading rate=inlet gas flow rate (m³/hr)×hydrogen sulfide concentration at gas inlet (mg/L)/volume of desulfurization reaction zone 100A (m³)

Elimination capacity=inlet gas flow rate (m³/hr)×hydrogen sulfide concentration at gas outlet (mg/L)/volume of desulfurization reaction zone 100A (m³)

Removal efficiency=(hydrogen sulfide concentration at gas inlet−hydrogen sulfide concentration at gas outlet)/hydrogen sulfide concentration at gas inlet×100%

TABLE 1

| | Test 1 | Test 2 | Test 3 | Test 4 | Test 5 |
|---|---|---|---|---|---|
| Total operation volume | 0.57 | 0.57 | 0.57 | 0.57 | 0.57 |
| of desulfurization | | | | | |
| reaction zone | | | | | |
| (m³) | | | | | |
| Inlet gas | 3 | 6 | 9 | 12 | 15 |
| flow rate (m³/hr) | | | | | |
| Gas residence | 11.2 | 5.6 | 3.73 | 2.8 | 2.24 |
| time (min) | | | | | |
| Hydrogen sulfide | 5784 | 5770 | 5277 | 4988 | 5133 |
| concentration at | | | | | |
| gas inlet (ppmV) | | | | | |
| Hydrogen sulfide | 46 | 93 | 127 | 160 | 206 |
| loading rate | | | | | |
| (gH₂S/m³hr) | | | | | |
| Hydrogen sulfide | 45 | 117 | 257 | 546 | 570 |
| concentration at | | | | | |
| gas outlet (ppmV) | | | | | |
| Elimination capacity | 46 | 91 | 121 | 143 | 183 |
| of hydrogen sulfide | | | | | |
| (gH₂S/m³hr) | | | | | |
| Removal efficiency | 99 | 98 | 95 | 89 | 89 |
| of hydrogen sulfide | | | | | |
| (%) | | | | | |

As shown in Table 1 and FIG. 2, when the test was performed at a lower hydrogen sulfide loading rate of 46 gH₂S/m³hr, the elimination capacity of hydrogen sulfide was 46 gH₂S/m³hr, and the removal efficiency of hydrogen sulfide was 99%. When the hydrogen sulfide loading rate was increased to 160 gH₂S/m³hr, the elimination capacity of hydrogen sulfide was slightly decreased, but the removal efficiency of hydrogen sulfide was still 89%. As shown above, under the condition where the hydrogen sulfide loading rate was in a range from about 40 to 130 gH₂S/m³hr, the biological desulfurization processing system provided in the present disclosure could reach a hydrogen sulfide removal efficiency of more than 95%. The above results showed that the biological desulfurization processing system of the present disclosure has good elimination capacity and removal efficiency of hydrogen sulfide.

### COMPARATIVE EXAMPLE 1

Comparison was made with the experimental data in the literature “Biogas biological desulphurisation under extremely acidic conditions for energetic valorisation in Solid Oxide Fuel Cells”, Chemical Engineering Journal 255 (2014) 677-685. In the aforementioned literature, the desulfurization reaction of biogas was carried out using a biological trickling filter. The filling materials in the desulfurization reaction tank were all HD-QPAC. Under the condition where the hydrogen sulfide loading rate was in a range from 170 to 209 gH₂S/m³hr (average was 195 gH₂S/m³hr), the elimination capacity of hydrogen sulfide was in a range from 142 to 190 gH₂S/m³hr (average was 169 gH₂S/m³hr), and the removal efficiency of hydrogen sulfide was in a range from 72 to 94% (average was 84%).

### COMPARATIVE EXAMPLE 2

Comparison was made with the experimental data in the literature “Performance and Economic Results for two Full Scale Biotrickling Filters to Remove H₂S from Dairy Manure-Derived Biogas”, Applied Engineering in Agriculture, 35(3), 283-291. In the aforementioned literature, the desulfurization reaction of biogas was carried out by using a biological trickling filter. The filling materials in the desulfurization reaction tank were all circular structures made of polypropylene. The experiments were implemented in Farm 1 and Farm 2. The desulfurization reaction tank of Farm 1 had two compartments (that is, there were two layers of compartments), while the desulfurization reaction tank of Farm 2 had only one compartment (that is, there was no multi-layer compartment). In farm 1, under the condition where the hydrogen sulfide loading rate was 33 gH₂S/m³hr, the elimination capacity of hydrogen sulfide was 94.5%. In farm 2, under the condition where the hydrogen sulfide loading rate was 37 gH₂S/m³hr, the elimination capacity of hydrogen sulfide was 80.1%.

According to the results of Example 1 and Comparative Examples 1 and 2, it can be seen that the biological desulfurization processing system provided in the present disclosure has better hydrogen sulfide elimination capacity and hydrogen sulfide removal efficiency under the same hydrogen sulfide loading rate.

To summarize the above, in the biological desulfurization processing system provided by the embodiments of the present disclosure, the desulfurization reaction tank includes desulfurization layer(s) and supporting layer(s) stacked in a staggered manner. Compared to the desulfurization system generally adopting the plate-shaped filling materials or a single type of filling material, the biological desulfurization processing system provided in the present disclosure can effectively increase the time that the gas to be processed stays in the desulfurization reaction tank to contact the desulfurization bacteria, thereby improving the desulfurization efficiency. Furthermore, the desulfurization layer and supporting layer with specific physical properties can further improve their filling capacity in the desulfurization reaction tank and increase the loading capacity of hydrogen sulfide, thereby reducing the initial setup cost of the processing system. In addition, the culture tank of desulfurization bacteria adopts an external aeration method, which can provide sufficient oxygen for a large number of desulfurization bacteria to use, and can prevent air from being mixed with the gas to be processed, and maintain a stable quality of intake gas.

Although some embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods or steps. In addition, each claim constitutes an individual embodiment, and the claimed scope of the present disclosure includes the combinations of the claims and embodiments. The scope of protection of present disclosure is subject to the definition of the scope of the appended claims.

What is claimed is:

1. A biological desulfurization processing method, comprising:
providing a biological desulfurization processing system, comprising:
a desulfurization reaction tank for receiving a gas containing hydrogen sulfide; and
a culture tank of desulfurization bacteria for cultivating desulfurization bacteria, connected to the desulfurization reaction tank;
wherein the desulfurization reaction tank comprises a desulfurization reaction zone, the desulfurization reaction zone comprises at least one desulfurization layer and at least one supporting layer, and the at least one desulfurization layer and the at least one supporting layer are stacked in a staggered manner;
loading a gas containing hydrogen sulfide into the biological desulfurization processing system, allowing the gas containing hydrogen sulfide to pass through the desulfurization reaction zone for a desulfurization reaction to remove hydrogen sulfide; and
discharging the gas that has been desulfurized from the desulfurization reaction tank.

2. The biological desulfurization processing method as claimed in claim 1, wherein a desulfurization bacteria in the culture tank of desulfurization bacteria is transported to the desulfurization reaction tank by a circulating fluid, and attached to the at least one desulfurization layer in the desulfurization reaction zone, and the desulfurization bacteria in the desulfurization reaction zone perform a desulfurization reaction on the gas containing hydrogen sulfide.

3. The biological desulfurization processing method as claimed in claim 2, wherein the desulfurization reaction tank further comprises a temporary storage zone located below the desulfurization reaction zone and connected with the desulfurization reaction zone, wherein the circulating fluid flows from the desulfurization reaction zone to the temporary storage zone, and a product of the desulfurization reaction is transported to the temporary storage zone.

4. The biological desulfurization processing method as claimed in claim 3, wherein the temporary storage zone is connected to the culture tank of desulfurization bacteria, and the circulating fluid is circulated to the culture tank of desulfurization bacteria to provide a nutrient for the desulfurization bacteria.

5. The biological desulfurization processing method as claimed in claim 1, wherein in the desulfurization reaction zone, a traveling direction of the circulating fluid is opposite to a traveling direction of the gas containing hydrogen sulfide.

6. The biological desulfurization processing method as claimed in claim 1, wherein the biological desulfurization processing system further comprises an aeration device connected to the desulfurization reaction tank and the culture tank of desulfurization bacteria, and wherein in a desulfurization mode of the biological desulfurization processing system, the aeration device transports air to the culture tank of desulfurization bacteria to provide oxygen for the desulfurization bacteria.

7. The biological desulfurization processing method as claimed in claim 1, wherein the biological desulfurization processing system further comprises an aeration device connected to the desulfurization reaction tank and the culture tank of desulfurization bacteria, and wherein in a cleaning mode of the biological desulfurization processing system, the aeration device transports air to the desulfurization reaction tank to wash the at least one desulfurization layer and the at least one supporting layer.

8. The biological desulfurization processing method as claimed in claim 1, wherein an inlet flow rate of the gas containing hydrogen sulfide is in a range from 0.01 m³/min to 10 m³/min.

9. The biological desulfurization processing method as claimed in claim 1, wherein a trickling flow rate of a circulating fluid in the biological desulfurization processing system is in a range from 20 m/hr to 50 m/hr.

10. The biological desulfurization processing method as claimed in claim 1, wherein the at least one desulfurization layer comprises a plurality of porous bio-carriers, the at least one supporting layer comprises a plurality of supporting elements, and a filling capacity of the plurality of porous bio-carriers and the plurality of supporting elements in the desulfurization reaction zone is in a range from 80% to 95%.

11. A biological desulfurization processing system, including:
a desulfurization reaction tank for receiving a gas containing hydrogen sulfide; and
a culture tank of desulfurization bacteria for cultivating desulfurization bacteria, connected to the desulfurization reaction tank;
wherein the desulfurization reaction tank comprises a desulfurization reaction zone, the desulfurization reaction zone comprises at least one desulfurization layer and at least one supporting layer, and the at least one desulfurization layer and the at least one supporting layer are stacked in a staggered manner.

12. The biological desulfurization processing system as claimed in claim 11, wherein the at least one desulfurization layer comprises a plurality of porous bio-carriers, the at least one supporting layer comprises a plurality of supporting elements, and the plurality of bio-carriers are greater in number than the plurality of supporting elements.

13. The biological desulfurization processing system as claimed in claim 12, wherein a filling capacity of the plurality of porous bio-carriers and the plurality of supporting elements in the desulfurization reaction zone is in a range from 80% to 95%.

14. The biological desulfurization processing system as claimed in claim 12, wherein a pore size of the porous bio-carrier is in a range from 200 micrometers to 2000 micrometers.

15. The biological desulfurization processing system as claimed in claim 12, wherein a porosity of the porous bio-carrier is less than a porosity of the supporting element.

16. The biological desulfurization processing system as claimed in claim 12, wherein a specific surface area of the porous bio-carrier is greater than a specific surface area of the supporting element.

17. The biological desulfurization processing system as claimed in claim 12, wherein a compressibility of the porous bio-carrier is greater than a compressibility of the supporting element.

18. The biological desulfurization processing system as claimed in claim 11, wherein a ratio of a total volume of the at least one desulfurization layer to a total volume of the at least one supporting layer is between 2:1 and 5:1.

19. The biological desulfurization processing system as claimed in claim 11, wherein one of the desulfurization layers and one of the supporting layers constitute a set of desulfurization unit, and the biological desulfurization processing system comprises 2 to 10 sets of desulfurization units.

20. The biological desulfurization processing system as claimed in claim 19, wherein in the desulfurization unit, a ratio of a volume of the desulfurization layer to a volume of the supporting layer is between 2:1 and 5:1.

21. The biological desulfurization processing system as claimed in claim 19, wherein a ratio of a height of the desulfurization unit to a height of the desulfurization reaction zone is between 1:1.5 and 1:6.5.

22. The biological desulfurization processing system as claimed in claim 11, wherein the desulfurization reaction tank further comprises a temporary storage zone, and the temporary storage zone is located below the desulfurization reaction zone and is connected with the desulfurization reaction zone.

23. The biological desulfurization processing system as claimed in claim 22, wherein the temporary storage zone is connected to the culture tank of desulfurization bacteria.

24. The biological desulfurization processing system as claimed in claim 11, further comprising an aeration device connected to a bottom of the desulfurization reaction tank and a bottom of the culture tank of desulfurization bacteria through a connection part.

25. The biological desulfurization processing system as claimed in claim 11, wherein the culture tank of desulfurization bacteria is connected to a top of the desulfurization reaction tank through a connecting part.

26. The biological desulfurization processing system as claimed in claim 11, further comprising a gas inlet and a gas outlet, wherein the gas inlet is disposed on a side surface of the desulfurization reaction tank and corresponds to the desulfurization reaction zone, and the gas outlet is disposed at a top of the desulfurization reaction tank.

27. The biological desulfurization processing system as claimed in claim 11, which has a volumetric loading rate of hydrogen sulfide in a range from 30 gH₂S/m³hr to 250 gH₂S/m³hr.
